(19) United States
(12) Patent Application Publication
(10) Pub. No.: US 2025/0119370 A1
(43) Pub. Date: Apr. 10, 2025

(54) Automated Connectivity Boundary Determination and Network Performance

(71) Applicant: The Boeing Company, Arlington, VA (US)

(72) Inventors: Christopher John Padilla-Diffoot, Mountlake Terrace, WA (US); Timothy W. Anstey, Seattle, WA (US); Yong Min Shin, Seoul (KR); Minji Park, Seoul (KR); Ikjun Jeon, Seoul (KR); Xavier Dawes, Wylie, TX (US); Bassam F. Halabiya, Lynnwood, WA (US); Stefanel Castro, Lynnwood, WA (US)

(21) Appl. No.: 18/746,780

(22) Filed: Jun. 18, 2024

Related U.S. Application Data
(60) Provisional application No. 63/588,116, filed on Oct. 5, 2023.

(51) Int. Cl. H04L 43/0811; H04W 40/24; H04W 64/00

(52) U.S. Cl. CPC H04L 43/0811; H04W 40/24; H04W 64/006

(57) ABSTRACT

Determining aircraft wireless connectivity is provided. The method comprises collating network file server (NFS) logs from a number of missions for an aircraft at a number of airports and collating geolocation data of the aircraft at the airports during the missions. The NFS logs are parsed for wireless connectivity performance metrics, and the wireless connectivity performance metrics are cross-referenced with the geolocation data to determine wireless connectivity boundaries according to location within the airports.

### CROSS-REFERENCE TO RELATED APPLICATION

This application claims the benefit of U.S. Provisional Patent Application Ser. No. 63/588, 116, filed Oct. 5, 2023, and entitled “Automated Connectivity Boundary Determination and Network Performance,” which is incorporated herein by reference in its entirety.

### BACKGROUND INFORMATION

### Technical Field

The present disclosure relates generally to wireless data transfer, and more specifically to wireless data transfer from aircraft.

### Background

Commercial aircraft generate large amounts of data during flight missions. This data relates to the operation of multiple systems onboard the aircraft. This data can be offloaded to ground stations via a number of different type of internet protocol (IP) wireless links. Examples of these types of IP links include cellular, Swift Broadband (SBB), and Broadband Offboard Satellite System (BOSS) satellite links. The availability and stability of these different IP links can vary according to factors such as the flight phase of the aircraft, geographical position of the aircraft, and infrastructure limitations at different locations.

### SUMMARY

An illustrative embodiment provides a computer-implemented method for determining aircraft wireless connectivity. The method comprises collating network file server (NFS) logs from a number of missions for an aircraft at a number of airports and collating geolocation data of the aircraft at the airports during the missions. The NFS logs are parsed for wireless connectivity performance metrics, and the wireless connectivity performance metrics are cross-referenced with the geolocation data to determine wireless connectivity boundaries according to location within the airports.

Another illustrative embodiment provides a system for determining aircraft wireless connectivity. The system comprises a storage device that stores program instructions and one or more processors operably connected to the storage device and configured to execute the program instructions to cause the system to: collate network file server (NFS) logs from a number of missions for an aircraft at a number of airports; collate geolocation data of the aircraft at the airports during the missions; parse the NFS logs for wireless connectivity performance metrics; cross-reference the wireless connectivity performance metrics with the geolocation data to determine wireless connectivity boundaries according to location within the airports.

Another illustrative embodiment provides a computer program product for determining aircraft wireless connectivity. The computer program product comprises a computer-readable storage medium having program instructions embodied thereon to perform the steps of: collating network file server (NFS) logs from a number of missions for an aircraft at a number of airports; collating geolocation data of the aircraft at the airports during the missions; parsing the NFS logs for wireless connectivity performance metrics; cross-referencing the wireless connectivity performance metrics with the geolocation data to determine wireless connectivity boundaries according to location within the airports.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an aircraft wireless connectivity evaluation system in accordance with an illustrative embodiment;

FIG. 2 depicts a diagram illustrating a process of determining wireless connectivity for a fleet of aircraft in accordance with an illustrative embodiment;

FIG. 3 depicts a display of wire connectivity boundaries in accordance with an illustrative embodiment;

FIG. 4 depicts an example dashboard display of IP link utilization in accordance with an illustrative embodiment;

FIG. 5 depicts a flowchart for a process of IP link analysis after parsing NFS log data in accordance with an illustrative embodiment;

FIG. 6 depicts a flowchart for IP link utilization post processing in accordance with an illustrative embodiment

FIG. 7 depicts a flowchart for IP link status post process in accordance with an illustrative embodiment;

FIG. 8 depicts a flowchart of a process for determining aircraft wireless connectivity in accordance with an illustrative embodiment; and

FIG. 9 is an illustration of a block diagram of a data processing system in accordance with an illustrative embodiment.

### DETAILED DESCRIPTION

The illustrative embodiments recognize and take into account that airlines currently contact aircraft manufacturers when wireless IP link connectivity issues arise with their airplanes because of the lack of traceability of the root cause.

The illustrative embodiments also recognize and take into account that once the aircraft manufacturer has been alerted to the problem, engineers have to parse through a large number of data logs to establish whether the connectivity issues reside with the aircraft in question or with airport infrastructure.

The illustrative embodiments also recognize and take into account that, currently, all management of IP links are managed by airplanes configured discreetly.

The illustrative embodiments provide a method of applying analytics of performance metrics for various IP links from historical data generated on an aircraft. With the additional use of geolocation data corresponding to these historical data points, the illustrative embodiments can create maps of airports to establish boundaries for good connectivity for different offboard connectivity options. Guidance can be provided to the airline regarding how to conduct data offload at airports in the most efficient manner.

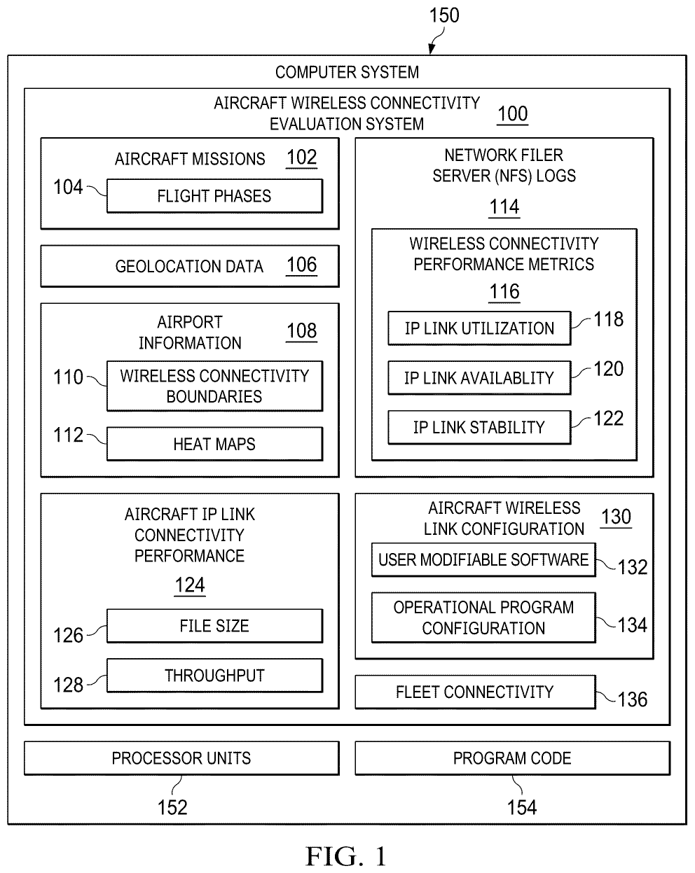

With reference now to FIG. 1, an illustration a block diagram of an aircraft wireless connectivity evaluation system is depicted in accordance with an illustrative embodiment. Aircraft wireless connectivity evaluation system 100 collates data from network file server (NFS) logs 114 for a number of aircraft missions 102 of an aircraft. From these NFS logs 114 aircraft wireless connectivity evaluation system 100 is able to determine a number of wireless connectivity performance metrics 116.

The wireless connectivity performance metrics 116 may relate to different aspects of the use of different IP links by the aircraft during the aircraft missions 102. Categories of IP link use and performance might include IP link utilization 118, IP link availability 120, and IP link stability 122.

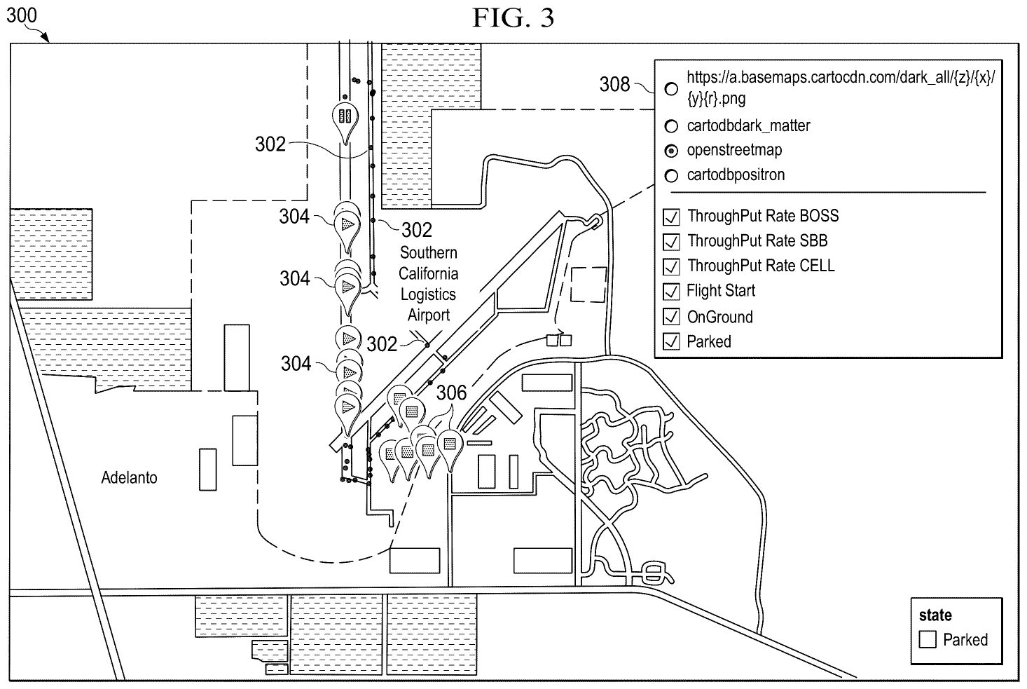

Aircraft wireless connectivity evaluation system 100 also collates geolocation data 106 that denotes where the aircraft was when the data in the NFS logs 114 was generated. By cross-referencing the wireless connectivity performance metrics 116 with the geolocation data 106, aircraft wireless connectivity evaluation system 100 can determine wireless connectivity boundaries 110, which may be represented by heat maps 112 (see FIG. 3). The wireless connectivity boundaries 110 and heat maps 112 can be associated with airport information 108 for a number of airports, which aircraft operators (airlines) can utilize to make decisions regarding where and when to best offload data via IP links.

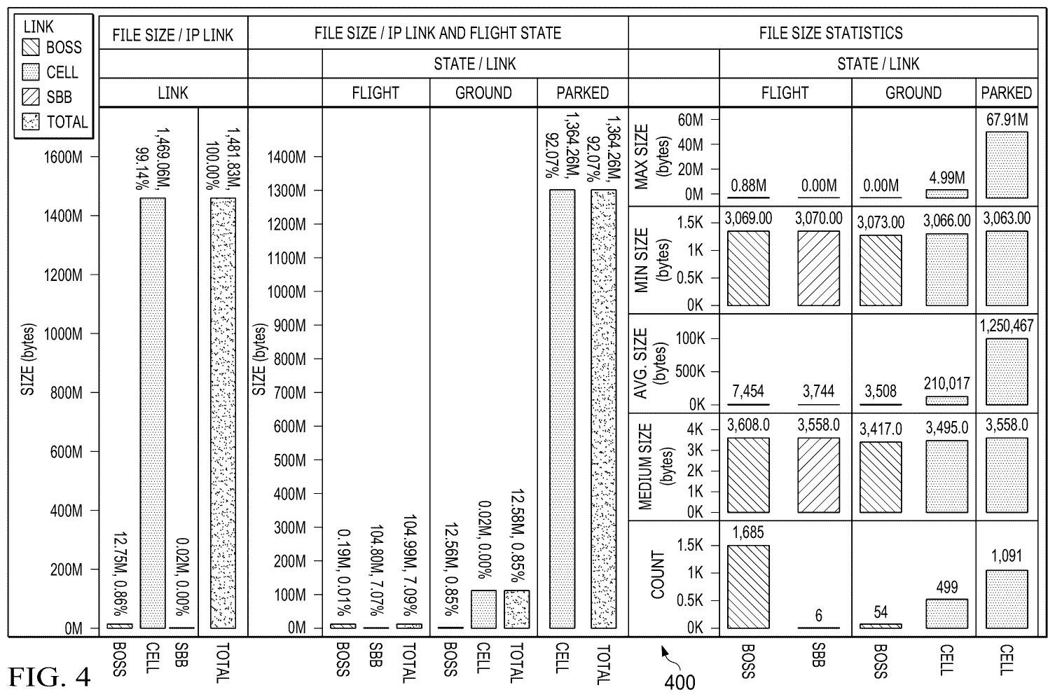

Aircraft wireless connectivity evaluation system 100 can determine the aircraft IP link connectivity performance 124 utilizing the wireless connectivity performance metrics 116 and data about flight phase 104 of aircraft missions 102 in combination with geolocation data 106 (see FIG. 4). Aircraft IP link connectivity performance 124 relates to the performance of the aircraft onboard systems such as file size 126 and throughput 128 through different IP links. This evaluation allows aircraft operators to better determine whether connectivity issues are arising from the aircraft itself or from the infrastructure. For example, if the aircraft exhibits the same IP connectivity issues related to IP link availability 120 and/or IP link stability 122 during the same flight phases 104 regardless of which airport the aircraft is at, that is a strong indication that the issue lies with the aircraft's onboard systems.

Aircraft wireless connectivity evaluation system 100 can also utilize the NFS logs 114 to determine the aircraft's wireless link configuration 130. This configuration might relate to the aircraft's user modifiable software 132 and operational program configuration 134. The manufacturer will design the aircraft in question to have certain potential capabilities. Determining the aircraft wireless link configuration 130 reveals which of those capabilities the aircraft operator has enabled. This insight includes determining which software parts the operator is using and whether there are any issues with that software. Aircraft wireless link configuration 130 can also reveal what ground servers and systems the operator is using and the IP links used to communicate with those systems.

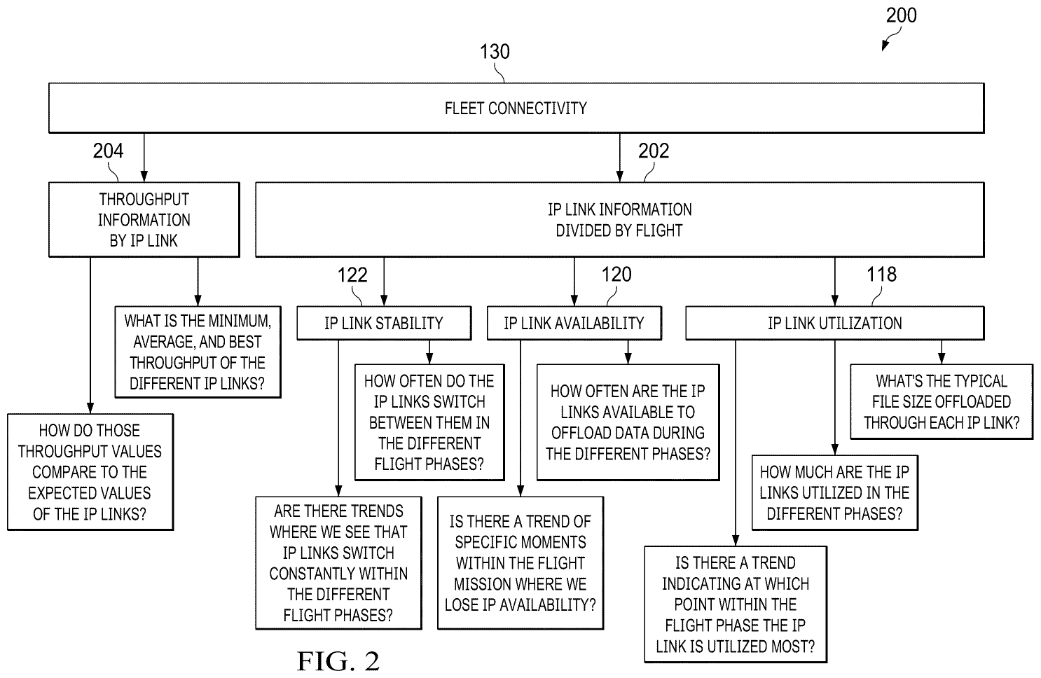

By aggregating the analysis of wireless connectivity across many aircraft, aircraft wireless connectivity evaluation system 100 can determine fleet connectivity 136 (see FIG. 2).

Aircraft wireless connectivity evaluation system 100 can be implemented in software, hardware, firmware, or a combination thereof. When software is used, the operations performed by aircraft wireless connectivity evaluation system 100 can be implemented in program code configured to run on hardware, such as a processor unit. When firmware is used, the operations performed by aircraft wireless connectivity evaluation system 100 can be implemented in program code and data and stored in persistent memory to run on a processor unit. When hardware is employed, the hardware can include circuits that operate to perform the operations in aircraft wireless connectivity evaluation system 100.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 150 is a physical hardware system and includes one or more data processing systems. When more than one data processing system is present in computer system 150, those data processing systems are in communication with each other using a communications medium. The communications medium can be a network. The data processing systems can be selected from at least one of a computer, a server computer, a tablet computer, or some other suitable data processing system.

As depicted, computer system 150 includes a number of processor units 152 that are capable of executing program code 154 implementing processes in the illustrative examples. As used herein a processor unit in the number of processor units 152 is a hardware device and is comprised of hardware circuits such as those on an integrated circuit that respond and process instructions and program code that operate a computer. When a number of processor units 152 execute program code 154 for a process, the number of processor units 152 is one or more processor units that can be on the same computer or on different computers. In other words, the process can be distributed between processor units on the same or different computers in a computer system. Further, the number of processor units 152 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

FIG. 2 depicts a diagram illustrating a process of determining wireless connectivity for a fleet of aircraft in accordance with an illustrative embodiment. Process 200 can be implemented in aircraft wireless connectivity evaluation system 100. FIG. 2 illustrates how fleet connectivity 130 can be determined by examining how individual planes are establishing and using wireless connectivity during missions with increasing levels of granularity.

Fleet connectivity 130 can be determined from the total IP link information divided by flight 202 and the throughput information per IP link 204. IP link information divided by flight 202 is a product of IP link utilization 118, IP link availability 120, and IP link stability 122.

IP link utilization 118 is determined according to three factors. The first factor is the typical file size offloaded through each IP link. The second factor is how much each IP link is utilized in different flight phases. The third factor is determining if there is a trend indicating at which point within each flight phase the IP link is utilized the most.

IP link availability 120 is determined according to two factors. The first factor is how often the IP links are available to offload data during the different flight phases. The second factor is determining whether there is a trend of specific moments within the flight mission where IP availability is lost.

IP link stability 122 is determined according to two factors as well. The first factor is how often IP links switch between each other in different flight phases. The second factor is determining whether there are trends where the IP links switch constantly within different flight phases.

The throughput information per IP link 204 is determined according to two factors. The first factor is the minimum, average, and best throughput for each of the IP links. The second factor is how those throughput values compare to expected values of the IP links.

FIG. 3 depicts a display of wire connectivity boundaries in accordance with an illustrative embodiment. FIG. 3 shows an airport diagram 300. Superimposed on the diagram are geolocation indicators 302 denoting the movement of an aircraft on the airport grounds.

Indicators 304 denote positions at which the aircraft was able to successfully offload data via IP links. Therefore, the display in FIG. 3 provides a convenient visualization of IP link connectivity according to geolocation, thereby allowing the aircraft operator to make better informed decisions regarding where and when to offload data for maximum efficiency.

Dashboard 308 allows the user to display connectivity according to specific IP links and aircraft operating conditions for.

FIG. 4 depicts an example dashboard display of IP link utilization in accordance with an illustrative embodiment. Dashboard 400 provides the user with a convenient visualization of data offload from the aircraft via different IP links. Dashboard 400 allows the user to evaluate IP link utilization according to a number of parameters such as file size, flight phase, and IP link type.

Using dashboard 400, the user can determine data traffic amounts for each IP link, IP link utilization in different flight phases, and statistics of file size transmitted in different flight phases to show typical offloaded file size in those phases.

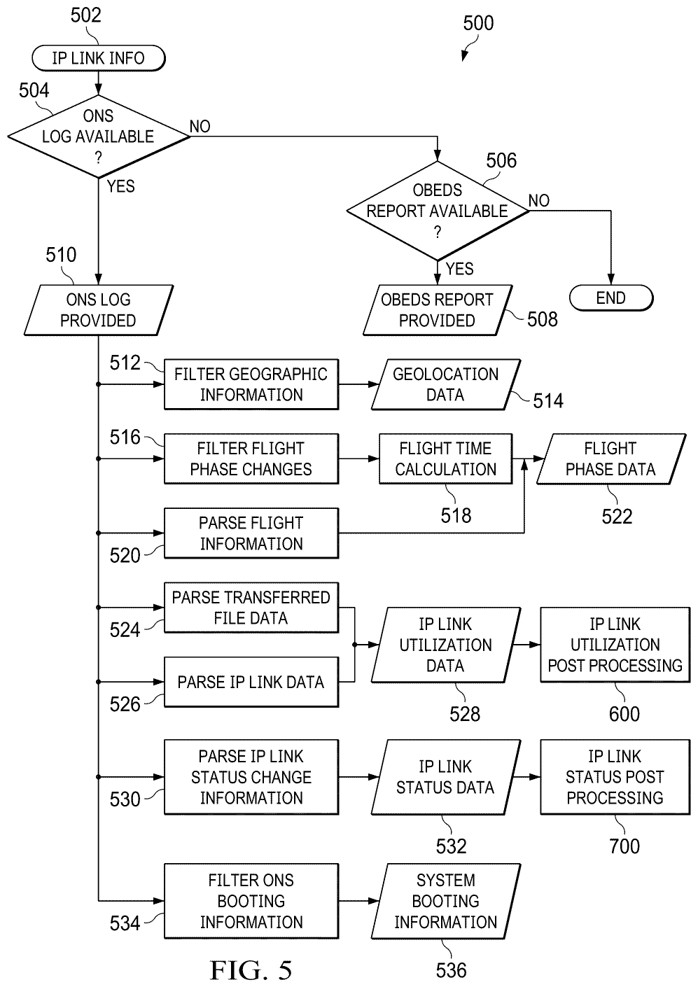

FIG. 5 depicts a flowchart for a process of IP link analysis after parsing NFS log data in accordance with an illustrative embodiment. Process 500 can be implemented in aircraft wireless connectivity evaluation system 100.

Process 500 begins with IP link information 502 and determines whether an ONS (Online Network System) log is available (operation 504). If there is no ONS log, process 500 determines whether there is an onboard electronic distribution of software (OBEDS) report available (operation 506). If there is no OBEDS report available, process 500 ends. If there is a OBEDS report available, it is provided (508).

If there is an ONS log 510 provided, process 500 performs a number of filtering and processing operations on it. Process 500 filters the ONS log 510 for geographic information (operation 512) to obtain geolocation data 514 which might include timestamp, latitude, and longitude.

Process 500 filters flight phase change events such as flight, ground, and parked (operation 516) and calculates flight time (operation 518) by determining the different between ground time and flight time. Process 500 also parses flight information (operation 520) including origin, destination, and flight number. From operations 518 and 520, process 500 is able to derive flight phase data 522, which includes timestamp, aircraft state, origin, destination, and flight time.

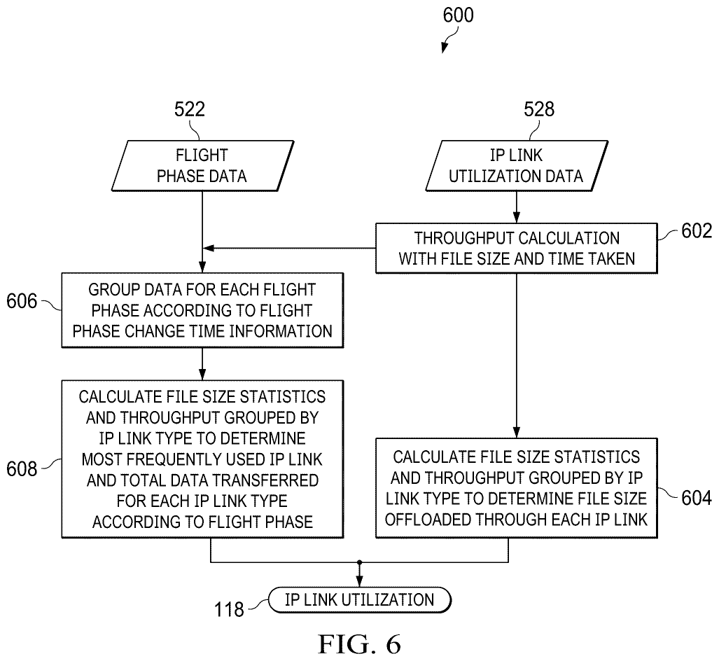

Process 500 derives IP link utilization data 528 by parsing transferred file data (operation 524) and parsing IP link data (operation 526). IP link utilization data 528 might include OBEDS ID, result, timestamp, file name, file size, time taken, application ID, data type, IP link type, and aircraft ID. IP link utilization data 528 is then fed into IP link utilization post processing 600 (see FIG. 6).

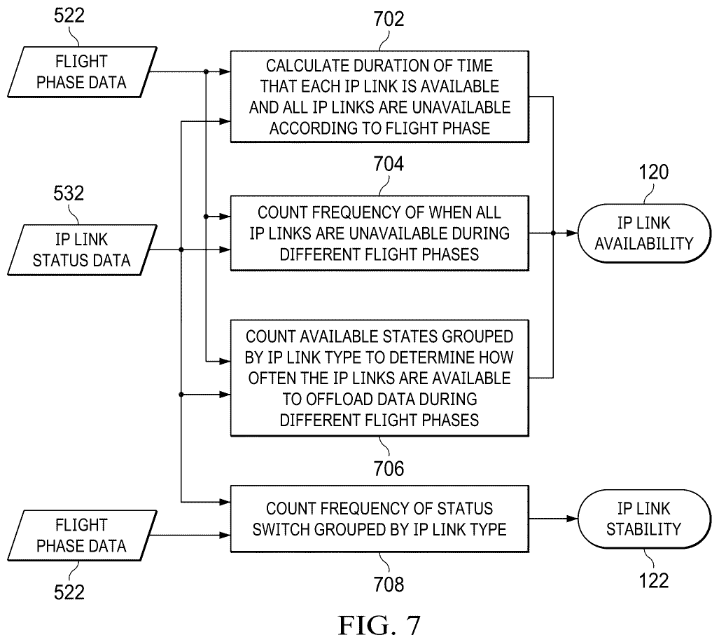

Process 500 parses IP link status change information (operation 530) to derive IP Link Status Data 532, which might include timestamp, ACARS (Aircraft Communications Addressing and Reporting System) link status, electronic flight bag communications management function (eCMF) link status, and OBEDS link status. IP Link Status Data 532 is fed into IP link status post processing 700 (see FIG. 7).

Process 500 also filter ONS booting information (operation 534) to derive system booting information 536, which contains timestamp information on ONS booting.

FIG. 6 depicts a flowchart for IP link utilization post processing in accordance with an illustrative embodiment. Process 600 utilizes input of IP link utilization data 528 and flight phase data 522 from process 500.

From IP link utilization data 528 process 600 performs a throughput calculation with file size and time taken (operation 602). From this calculation process 600 calculates file size statistics (i.e., minimum, maximum, mean, median, etc.) and throughput grouped by IP link type to determine file size offloaded through each IP link (operation 604).

From the throughput calculation from operation 602 and flight phase data 522, process 600 groups data for each flight phase according to flight phase change time information (operation 606). This grouped data is then used to calculate file size statistics and throughput grouped by IP link type to determine the most frequently used IP link and total data transferred for each IP link type according to flight phase (operation 608). From the calculations in operations 604 and 608, process 600 determines overall IP link utilization 118.

FIG. 7 depicts a flowchart for IP link status post process in accordance with an illustrative embodiment. Process 700 utilizes input of IP link status data 532 and flight phase data 522 from process 500.

Process 700 calculates the duration of time that each IP link is available and all IP links are unavailable according to flight phase (operation 702).

Process 700 counts the frequency of when all IP links are unavailable during different flight phases (operation 704).

Process 700 counts available states grouped by IP link type to determine how often the IP links are available to offload data during different flight phases (operation 706). From the results of operations 702, 704, and 706, process 700 derives IP link availability 120.

Using IP link status data 532 and flight phase data 522, process 700 also counts the frequency of status switch grouped by IP link type 708, which allows process 700 to determine IP link stability 122.

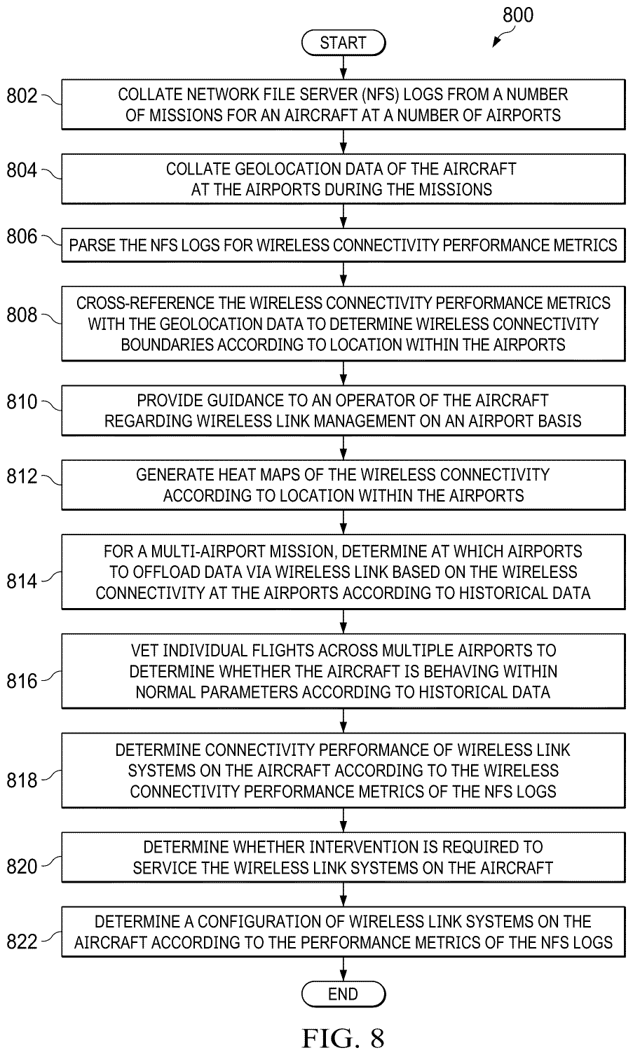

FIG. 8 depicts a flowchart of a process for determining aircraft wireless connectivity in accordance with an illustrative embodiment. Process 800 can be implemented in hardware, software, or both. When implemented in software, the process can take the form of program code that is run by one of more processor units located in one or more hardware devices in one or more computer systems. For example, process 900 can be implemented in aircraft wireless connectivity evaluation system 100 in FIG. 2.

Process 800 begins by collating network file server (NFS) logs from a number of missions for an aircraft at a number of airports (operation 802). Process 800 also collates geolocation data of the aircraft at the airports during the missions (operation 804).

Process 800 parses the NFS logs for wireless connectivity performance metrics (operation 806) and cross-references the wireless connectivity performance metrics with the geolocation data to determine wireless connectivity boundaries according to location within the airports (operation 808).

Based on the connectivity boundaries, process 800 provides guidance to an operator of the aircraft regarding wireless link management on an airport basis (operation 810) and may generate a heat map of the wireless connectivity according to location within the airports (operation 812).

For a multi-airport mission, process 800 determines at which airports to offload data via wireless link based on the wireless connectivity at the airports according to historical data (operation 814).

Process 800 vets individual flights across multiple airports to determine whether the aircraft is behaving within normal parameters according to historical data (operation 816).

Process 800 determines connectivity performance of wireless link systems on the aircraft according to the performance metrics of the NFS logs (operation 818), and based on this connectivity performance, determines whether intervention is required to service the wireless link systems on the aircraft (operation 820).

Process 800 determines a configuration of wireless link systems on the aircraft according to the performance metrics of the NFS logs (operation 822). Process 800 then ends.

The flowchart and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

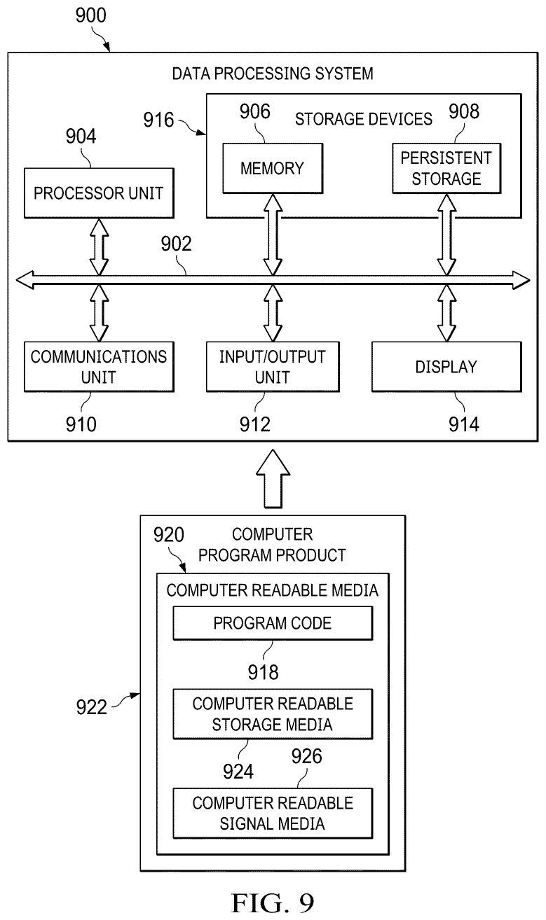

Turning now to FIG. 9, an illustration of a block diagram of a data processing system is depicted in accordance with an illustrative embodiment. Data processing system 900 may be used to implement computer system 150 in FIG. 1. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that may be loaded into memory 906. Processor unit 904 may be a number of processors, a multi-processor core, or some other type of processor, depending on the particular implementation. In an embodiment, processor unit 904 comprises one or more conventional general-purpose central processing units (CPUs). In an alternate embodiment, processor unit 904 comprises one or more graphical processing units (GPUS).

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Memory 906, in these examples, may be, for example, a random access memory or any other suitable volatile or non-volatile storage device. Persistent storage 908 may take various forms, depending on the particular implementation.

For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908. Communications unit 910, in these illustrative examples, provides for communications with other data processing systems or devices. In these illustrative examples, communications unit 910 is a network interface card.

Input/output unit 912 allows for input and output of data with other devices that may be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs may be located in storage devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer-usable program code, or computer-readable program code that may be read and executed by a processor in processor unit 904. The program code in the different embodiments may be embodied on different physical or computer-readable storage media, such as memory 906 or persistent storage 908.

Program code 918 is located in a functional form on computer-readable media 920 that is selectively removable and may be loaded onto or transferred to data processing system 900 for execution by processor unit 904. Program code 918 and computer-readable media 920 form computer program product 922 in these illustrative examples. In one example, computer-readable media 920 may be computer-readable storage media 924 or computer-readable signal media 926.

In these illustrative examples, computer-readable storage media 924 is a physical or tangible storage device used to store program code 918 rather than a medium that propagates or transmits program code 918. Computer readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 918 may be transferred to data processing system 900 using computer-readable signal media 926. Computer-readable signal media 926 may be, for example, a propagated data signal containing program code 918. For example, computer-readable signal media 926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different embodiments may be implemented. The different illustrative embodiments may be implemented in a data processing system including components in addition to or in place of those illustrated for data processing system 900. Other components shown in FIG. 9 can be varied from the illustrative examples shown. The different embodiments may be implemented using any hardware device or system capable of running program code 918.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for determining aircraft wireless connectivity, the method comprising:
using a number of processors to perform:
collating network file server (NFS) logs from a number of missions for an aircraft at a number of airports;
collating geolocation data of the aircraft at the airports during the missions;
parsing the NFS logs for wireless connectivity performance metrics; and
cross-referencing the wireless connectivity performance metrics with the geolocation data to determine wireless connectivity boundaries according to location within the airports.

2. The method of claim 1, further comprising providing guidance to an operator of the aircraft regarding wireless link management on an airport basis.

3. The method of claim 1, further comprising:
determining connectivity performance of wireless link systems on the aircraft according to the wireless connectivity performance metrics of the NFS logs; and
determining whether intervention is required to service the wireless link systems on the aircraft.

4. The method of claim 1, further comprising determining a configuration of wireless link systems on the aircraft according to the performance metrics of the NFS logs.

5. The method of claim 1, further comprising generating heat maps of the wireless connectivity according to location within the airports.

6. The method of claim 1, further comprising vetting individual flights across multiple airports to determine whether the aircraft is behaving within normal parameters according to historical data.

7. The method of claim 1, further comprising, for a multi-airport mission, determining at which airports to offload data via wireless link based on the wireless connectivity at the airports according to historical data.

8. A system for determining aircraft wireless connectivity, the system comprising:
a storage device that stores program instructions;
one or more processors operably connected to the storage device and configured to execute the program instructions to cause the system to:
collate network file server (NFS) logs from a number of missions for an aircraft at a number of airports;
collate geolocation data of the aircraft at the airports during the missions;
parse the NFS logs for wireless connectivity performance metrics; and
cross-reference the wireless connectivity performance metrics with the geolocation data to determine wireless connectivity boundaries according to location within the airports.

9. The system of claim 8, wherein the processors further execute instructions to provide guidance to an operator of the aircraft regarding wireless link management on an airport basis.

10. The system of claim 8, wherein the processors further execute instructions to:
determine connectivity performance of wireless link systems on the aircraft according to the wireless connectivity performance metrics of the NFS logs; and
determine whether intervention is required to service the wireless link systems on the aircraft.

11. The system of claim 8, wherein the processors further execute instructions to determine a configuration of wireless link systems on the aircraft according to the performance metrics of the NFS logs.

12. The system of claim 8, wherein the processors further execute instructions to generate heat maps of the wireless connectivity according to location within the airports.

13. The system of claim 8, wherein the processors further execute instructions to vet individual flights across multiple airports to determine whether the aircraft is behaving within normal parameters according to historical data.

14. The system of claim 8, wherein the processors further execute instructions to, for a multi-airport mission, determine at which airports to offload data via wireless link based on the wireless connectivity at the airports according to historical data.

15. A computer program product for determining aircraft wireless connectivity, the computer program product comprising:
a computer-readable storage medium having program instructions embodied thereon to perform the steps of:
collating network file server (NFS) logs from a number of missions for an aircraft at a number of airports;
collating geolocation data of the aircraft at the airports during the missions;
parsing the NFS logs for wireless connectivity performance metrics; and
cross-referencing the wireless connectivity performance metrics with the geolocation data to determine wireless connectivity boundaries according to location within the airports.

16. The computer program product of claim 15, further comprising instructions for providing guidance to an operator of the aircraft regarding wireless link management on an airport basis.

17. The computer program product of claim 15, further comprising instructions for:
determining connectivity performance of wireless link systems on the aircraft according to the wireless connectivity performance metrics of the NFS logs; and
determining whether intervention is required to service the wireless link systems on the aircraft.

18. The computer program product of claim 15, further comprising instructions for determining a configuration of wireless link systems on the aircraft according to the performance metrics of the NFS logs.

19. The computer program product of claim 15, further comprising instructions for generating heat maps of the wireless connectivity according to location within the airports.

20. The computer program product of claim 15, further comprising instructions for vetting individual flights across multiple airports to determine whether the aircraft is behaving within normal parameters according to historical data.

21. The computer program product of claim 15, further comprising, for a multi-airport mission, instructions for determining at which airports to offload data via wireless link based on the wireless connectivity at the airports according to historical data.
